(19) United States
(12) Patent Application Publication
(10) Pub. No.: US 2009/0109859 A1
(43) Pub. Date: Apr. 30, 2009

(54) Method and System for Detecting a Fault Condition Based on Failed IGMP Join Attempts

(75) Inventors: Moshiur Rahman, Marlboro, NJ (US); Zhi Li, Martinez, CA (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/931,956

(22) Filed: Oct. 31, 2007

(51) Int. Cl. G06F 11/30

(52) U.S. Cl. 370/242

(57) ABSTRACT

A fault condition is detected based on determining that a number of failed Internet Group Management Protocol (IGMP) join attempts from at least one end device is greater than or equal to a threshold.

### FIELD OF THE DISCLOSURE

The present disclosure is generally related to detecting a fault condition in a network.

### BACKGROUND

Internet Protocol Television (IPTV) services use an Internet Protocol (IP) to provide video content to end users via a network. A fault condition in the network may lead to degradation in a quality of the IPTV service.

### BRIEF DESCRIPTION OF THE DRAWINGS

FIG. 1 is a flow chart of an embodiment of a method of monitoring a network;

FIG. 2 is a block diagram of an embodiment of a system for monitoring the network; and

FIG. 3 is a block diagram of an illustrative embodiment of a general computer system.

### DETAILED DESCRIPTION OF THE DRAWINGS

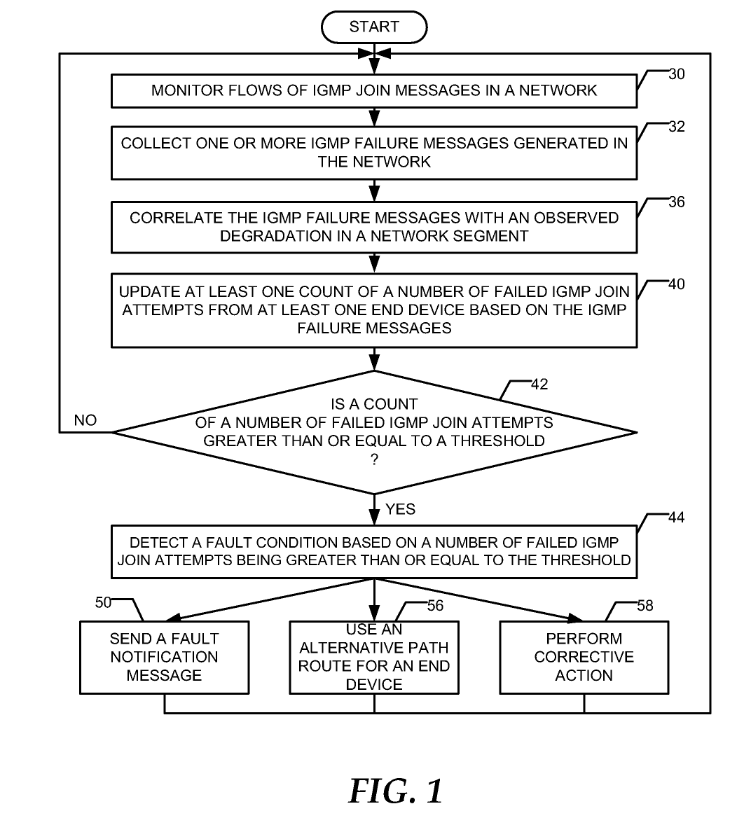

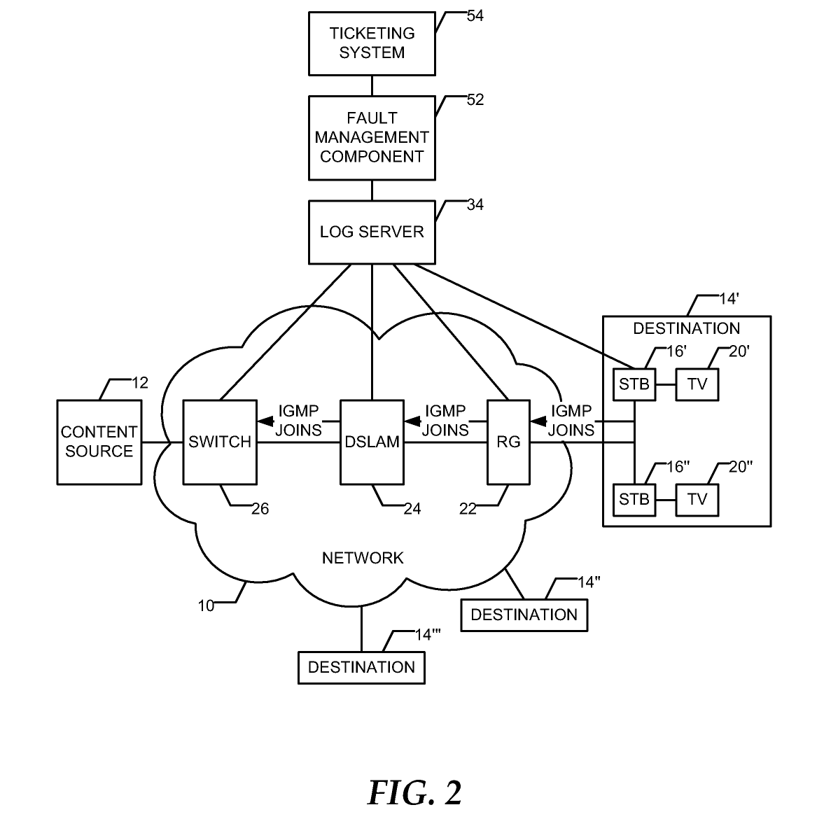

Disclosed herein are embodiments of methods and systems that detect a fault condition based on determining that a number of failed Internet Group Management Protocol (IGMP) join attempts from at least one end device is greater than or equal to a threshold. Embodiments are described with reference to FIG. 1, which is a flow chart of an embodiment of a method of monitoring a network 10, and FIG. 2, which is a block diagram of an embodiment of a system for monitoring the network 10.

The network 10 is used to communicate content, such as video content, from a source 12 to one or more destinations 14. Examples of the network 10 include, but are not limited to, an Internet Protocol (IP) network such as an IP video network. Examples of the source 12 include, but are not limited to, a video hub office, a central office and an intermediate office. Examples of the destinations 14 include, but are not limited to, one or more end user premises and one or more end user devices. In an embodiment, a destination may comprise one or more set-top boxes 16 or alternative IPTV clients that cooperate with one or more televisions 20, respectively, to receive and display video content to one or more end users of an IPTV service.

The source 12 has one or more network servers that serve the content, such as the video content, to the one or more destinations 14. Examples of the video content include, but are not limited to, live television content, archived television content, video-on-demand content, and movies. The source 12 may provide content to a destination based on a specific request for the content by the destination.

A protocol, such as IGMP, is used by the network 10 to setup a logical connection between each of the destinations 14 and the source 12. In an embodiment, an IGMP join attempt is initiated by a set-top box (or another device at a destination) to attempt to setup a multicast hierarchical tree logical connection with a network server at the source 12. The IGMP join attempt may comprise an IGMP join message initiated from the set-top box (or another device at a destination) and intended to terminate at the network server at the source 12. The IGMP join message may be communicated to the network server via a path comprising a residential gateway (RG) 22, a digital subscriber line access multiplexer (DSLAM) 24, and a switch 26. A fault in the network 10, however, may cause the IGMP join attempt to fail. If the IGMP join attempt fails, a failure message is generated in the network 10.

As indicated by block 30, the method comprises monitoring flows of IGMP join messages in the network 10. The flows of IGMP join messages may be monitored at different points in the network 10 between the destinations 14 and the source 12. In an embodiment, the IGMP join messages are monitored at the set-top box 16′, the RG 22, the DSLAM 24 and the switch 26.

As indicated by block 32, the method comprises collecting one or more IGMP failure messages generated in the network 10. The IGMP failure messages may be collected from one or more different points in the network 10 by a log server 34. In an embodiment, the IGMP failure messages are collected from at least one set-top box, at least one RG, at least one DSLAM, and at least one switch in the network 10. For example, the IGMP failure messages may comprise an IGMP failure message generated at a respective interface of the RG 22, the DSLAM 24, the switch 26, or another component in a path from a video end device to a video server.

Optionally, as indicated by block 36, the method comprises correlating the IGMP failure messages with an observed degradation in a network segment. The observed degradation may be an observed frame loss, packet loss, lag, or other IP layer data in the network segment. To correlate failure messages with degradation, this act may comprise storing first data that indicates a particular IGMP failure message, second data that indicates a particular observed degradation, and third data that indicates a particular network segment, and associating the first, second and third data in a database. The associated data can be used to pinpoint a particular port or interface to examine if a fault condition is detected. The act of correlating the IGMP failure messages with the observed degradation may be performed by the log server 34 or another component.

As indicated by block 40, the method comprises updating at least one count of a number of failed IGMP join attempts from at least one video end device based on the one or more IGMP failure messages. The act of updating at least one count may be performed by the log server 34 or another component.

In an embodiment, a respective count is maintained for each of a plurality of different components in the network 10. For example, a first count can be maintained for the RG 22, a second count can be maintained for the DSLAM 24 and a third count can be maintained for the switch 26. In an embodiment, the counts include only those failed IGMP join attempts that occur within a particular time interval. In this case, a count of a number of failed IGMP join attempts may exclude at least one failed IGMP join attempt that is not within the particular time interval (e.g. at least one IGMP join attempt that occurred at a time earlier than the present time minus the particular time interval).

As indicated by block 42, the method comprises determining if a count of a number of failed IGMP join attempts is greater than or equal to a threshold. In an embodiment, this act comprises comparing each respective count to a respective threshold, wherein different components in the network 10 may have either the same or different thresholds. Some or all of the thresholds may have a value that is greater than one. This act may be performed by the log server 34 or another component.

As indicated by block 44, the method comprises detecting a fault condition based on determining that a number of failed IGMP join attempts from at least one video end device is greater than or equal to a threshold. This act may be performed by the log server 34 or another component.

The number of failed IGMP join attempts that trigger the fault condition may occur without an outage of the network 10. For example, the fault condition may not have caused a major outage in the network 10 at the time of its being detected, but may lead to significant network problem if not corrected.

The detection of the fault condition may provide a prediction of which video network segment, between a network server and a video end device, is potentially at fault. The fault prediction can be based on the IP layer data that is correlated with the IGMP failure messages logged in the logical connectivity setup.

Any one or more of the following acts may be performed based on detecting the fault condition. As indicated by block 50, the method may comprise sending a fault notification message based on detecting the fault condition. In an embodiment, a trap is sent to a fault manager (FM) component 52 when the threshold has been exceeded for a specified time, and the FM component 52 in turn sends a fault notification message to a ticketing system 54 for trouble resolution. As indicated by block 56, the method may comprise using an alternative path route for the video end device based on detecting the fault condition. As indicated by block 58, other types of corrective action can be performed based on detecting the fault condition in order to promote a high video service delivery quality, and to avoid potential network failure and/or a major network failure.

By monitoring and analyzing IGMP joins used in multicast operation to setup a hierarchical tree between the network servers and the end user devices, such as RGs and set-top boxes, embodiments leverage the IGMP protocol to find a possible fault that has not yet caused a major outage in the network. Embodiments can be used with a video service assurance solution that monitors IP-based video performance in real-time to detect and predict faults both horizontally (i.e. across network segments) and vertically (i.e. across protocol layers).

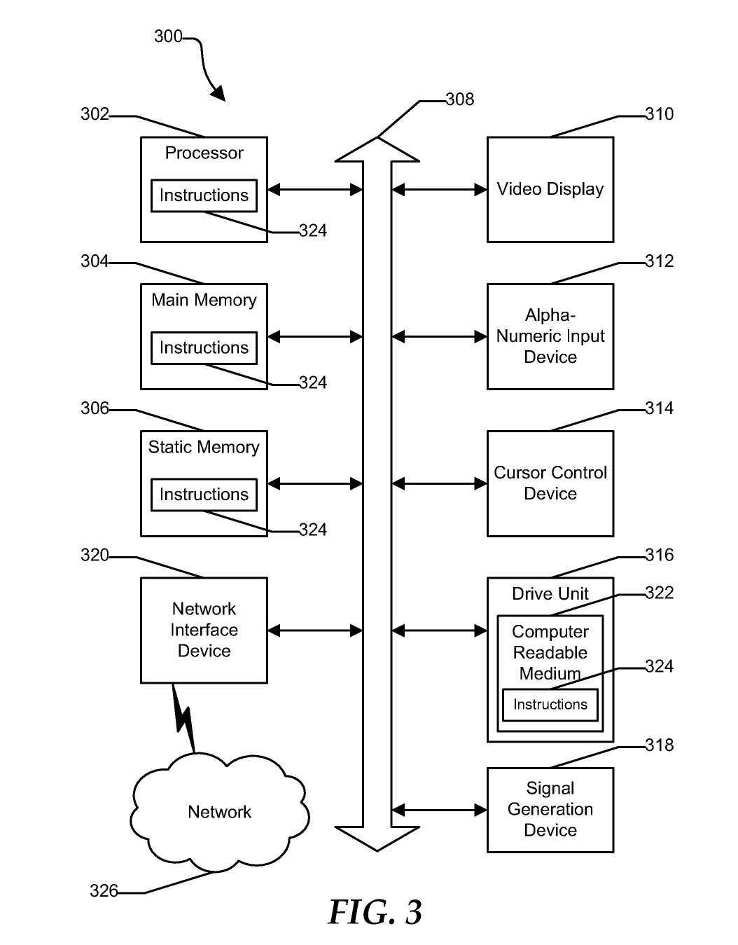

Referring to FIG. 3, an illustrative embodiment of a general computer system is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 can include a main memory 304 and a static memory 306, that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
detecting a fault condition based on determining that a number of failed Internet Group Management Protocol (IGMP) join attempts from at least one end device is greater than or equal to a threshold.

2. The method of claim 1 further comprising:
sending a fault notification message based on said detecting the fault condition.

3. The method of claim 2 wherein said sending comprises sending the fault notification message to a ticketing system for trouble resolution.

4. The method of claim 1 further comprising:
using an alternative path route for the end device based on said detecting the fault condition.

5. The method of claim 1 wherein the number of failed IGMP join attempts excludes at least one failed IGMP join attempt that is not within a particular time interval.

6. The method of claim 1 wherein the number of failed IGMP join attempts occur without a network outage.

7. The method of claim 1 further comprising:
collecting a plurality of IGMP failure messages from at least one residential gateway, at least one digital subscriber line access multiplexer (DSLAM), and at least one switch that are in a path from the at least one end device to a video server;
wherein said detecting the fault condition is based on said collecting.

8. The method of claim 1 further comprising:
correlating the IGMP failure messages with an observed degradation in a network segment.

9. The method of claim 1 further comprising:
correlating the IGMP failure messages with Internet Protocol (IP) layer data in a network segment.

10. The method of claim 1 further comprising:
correlating the IGMP failure messages with frame loss.

11. A system comprising:
a computer system programmed to detect a fault condition based on determining that a number of failed Internet Group Management Protocol (IGMP) join attempts from at least one end device is greater than or equal to a threshold.

12. The system of claim 11 wherein the computer system is to send a fault notification message based on detecting the fault condition.

13. The system of claim 12 wherein the fault notification message is sent to a ticketing system for trouble resolution.

14. The system of claim 11 wherein the computer system is to cause an alternative path route to be used for the end device based on detecting the fault condition.

15. The system of claim 11 wherein the number of failed IGMP join attempts excludes at least one failed IGMP join attempt that is not within a particular time interval.

16. The system of claim 11 wherein the number of failed IGMP join attempts occur without a network outage.

17. The system of claim 11 wherein the computer system is to collect a plurality of IGMP failure messages from at least one residential gateway, at least one digital subscriber line access multiplexer (DSLAM), and at least one switch that are in a path from the at least one end device to a video server, and wherein the fault condition is detected based on the plurality of IGMP failure messages.

18. The system of claim 11 wherein the computer system is to correlate the IGMP failure messages with an observed degradation in a network segment.

19. The system of claim 11 wherein the computer system is to correlate the IGMP failure messages with Internet Protocol (IP) layer data in a network segment.

20. The system of claim 11 wherein the computer system is to correlate the IGMP failure messages with frame loss.

21. A computer-readable storage medium encoded with a computer program, the computer program to cause a computer system to detect a fault condition based on determining that a number of failed Internet Group Management Protocol (IGMP) join attempts from at least one end device is greater than or equal to a threshold.
